(19) United States
(12) Patent Application Publication
(10) Pub. No.: US 2017/0020165 A1
(43) Pub. Date: Jan. 26, 2017

(54) ISO-ALPHA ACID TINCTURES AND CARBONATED BEVERAGE COMPOSITIONS INCLUDING THE SAME

(71) Applicant: 48th Parallel Incorporated, Cincinnati, OH (US)

(72) Inventor: Anthony Sean Moore, Cincinnati, OH (US)

(73) Assignee: 48th Parallel Incorporated, Cincinnati, OH (US)

(21) Appl. No.: 14/805,836

(22) Filed: Jul. 22, 2015

(51) Int. Cl. A23L 1/221; A23L 2/54; A23L 2/38; A23L 2/60; A23L 2/56; A23L 2/68

(52) U.S. Cl. CPC A23L 1/221; A23L 2/56; A23L 2/68; A23L 2/38; A23L 2/60; A23L 2/54; A23V 2002/00

(57) ABSTRACT

According to embodiments, a hop tincture includes from about 20.0% to about 95.0% alcohol solution by weight based on the hop tincture and from about 5.0% to about 50.0% at least one hop extract solution by weight based on the hop tincture. Also described are carbonated beverages including carbonated water, sweetener, an acidulant, and the hop tincture and methods for making the hop tincture.

### FIELD

The present specification generally relates to iso-alpha acid tinctures and carbonated beverage compositions including the same, and more particularly, to tinctures including iso-alpha acids extracted from hops and non-alcoholic carbonated beverages comprising the same.

### TECHNICAL BACKGROUND

Typically, quinine is used in beverages as a bittering agent. However, consumers now desire that products have more natural ingredients. Moreover, quinine's toxicity has led to regulation of the component by the FDA. For example, nonmedical use of quinine is limited to between 83 and 85 ppm.

Accordingly, a need exists for alternative naturally-derived bittering agents, flavor compositions including those bittering agents, and carbonated beverages with a bitter flavor.

### SUMMARY

According to one embodiment, a hop tincture includes from about 20.0% to about 95.0% alcohol solution by weight based on the hop tincture and from about 5.0% to about 50.0% at least one hop extract solution by weight based on the hop tincture.

According to another embodiment, a carbonated beverage includes water, sweetener, citric acid, and a hop tincture. The hop tincture includes from about 20.0% to about 95.0% alcohol solution by weight based on the hop tincture and from about 5.0% to about 50.0% at least one hop extract solution by weight based on the hop tincture.

According to another embodiment, a method of making a hop tincture includes mixing components of the hop tincture in a vessel, chilling the mixed components, and filtering the mixed components to yield the hop tincture. The components of the hop tincture include from about 20.0% to about 95.0% alcohol solution by weight based on the hop tincture and from about 5.0% to about 50.0% at least one hop extract solution by weight based on the hop tincture. The mixture is chilled to a temperature from about −5° C. to about 5° C. for about 6 to about 24 hours.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various aspects and embodiments and are intended to provide an overview or framework for understanding the nature and character of the claimed subject matter.

### DETAILED DESCRIPTION

Reference will now be made in detail to various embodiments of hop tinctures including hop extracts and carbonated beverages including the same. The components of the hop tincture may generally include alcohol and at least one hop extract solution. The hop tincture relies on amounts of naturally-derived hop extracts to provide a desired flavor without the use of quinine or other potentially toxic flavors. Accordingly, when the hop tincture is included in a carbonated beverage, it has a taste and appearance similar to bitter beverage products that include quinine and are desired by consumers. In one embodiment, a hop tincture includes from about 20.0% to about 95.0% alcohol solution by weight based on the hop tincture and from about 5.0% to about 50.0% at least one hop extract solution by weight based on the hop tincture. In another embodiment a carbonated beverage including the hop tincture is provided. Various embodiments of hop tinctures, carbonated beverages with the hop tincture, and methods of making the same will be described.

As used herein, a “wt %,” “weight percent,” or “percent by weight,” unless specifically stated to the contrary, is based on the total weight of the hop tincture. As used herein, “tetrahydroiso-α-acid,” “rho-iso-α-acid,” and “hexahydroiso-α-acid,” include extracts, derivatives, and salts formed from each of these components. As used herein “iso-α-acids” includes tetrahydroiso-α-acid, rho-iso-α-acid, hexahydroiso-α-acid, extracts, derivatives, and salts formed from each of these components.

As used herein, “IBU,” unless specifically stated to the contrary, refers to the International Bittering Units scale, and is a measure of concentration in parts per million (ppm) w/v of iso-α-acids in the beverage.

Specific and preferred values disclosed for components, ingredients, additives, temperatures, times, and like aspects, and ranges thereof, are for illustration only. They do not exclude other defined values or other values within defined ranges. The tinctures, apparatuses, and methods of the disclosure include those having any value or combination of the values, specific values, or ranges thereof described herein.

In various embodiments, the components of the carbonated beverage include carbonated water and the hop tincture, which includes one or more iso-α-acids. In some embodiments, instead of adding carbonated water, the carbonation may be added at another point in the process, such as just prior to serving the beverage. For example, beverage ingredients may be mixed in a container and charged with CO₂ gas to reach a desired level of carbonation and bottled under pressure. As another example, beverage ingredients may be added to a container at a high concentration to form a syrup and pre-carbonated water is added to the container. The mixture may then be carbonated.

In various embodiments, the carbonated beverage also includes a sweetener and an acidulant. The sweetener can be, by way of example and not limitation, a sugar, such as sucrose, fructose, cane sugar, and the like, a fruit juice, a sugar alcohol, a stevia extract, an artificial sweetener, or a combination thereof. The acidulant can be, by way of example and not limitation, citric acid, malic acid, a citrus fruit juice, phosphoric acid, or a combination thereof. In various embodiments, the acidulant may be used to enhance flavor, adjust the pH of the beverage, and provide anti-bacterial properties. According to various embodiments, the acidulant is added in an amount sufficient to produce a mixture with a pH of from about 1 to about 4. In some embodiments, one or more additional flavors or flavor extracts may be added. For example, lemon, lime, grapefruit, ginger, or other flavors may be added.

In various embodiments, the carbonated beverage has an IBU of from about 1 to about 120. In other words, in various embodiments, the carbonated beverage has from about 1 to about 120 ppm of iso-α-acids. However, in various embodiments, the carbonated beverage is non-alcoholic. In other words, in various embodiments, the carbonated beverage contains less than 0.5% alcohol by volume. In some embodiments, the carbonated beverage contains substantially no alcohol.

In various embodiments, the hop tincture includes an alcohol solution and at least one hop extract solution. In some embodiments, water may be added to the hop tincture. In some embodiments, the hop tincture may include ethyl alcohol with or without depotabilizing agents. In embodiments in which depotabilizing agents are included, the alcohol solution may be referred to as a “depotabilized alcohol solution.” Regardless of the presence of depotabilizing agents, the ethyl alcohol may be, for example, 190-200 proof (95%-100% alcohol by volume) ethyl alcohol derived from cane sugar, corn, grain, fruit, or the like. In various embodiments, the hop tincture includes from about 20.0% to about 95.0% alcohol solution by weight based on the hop tincture. Some embodiments include from about 20.0% to about 40% alcohol solution by weight based on the hop tincture. Some embodiments include from about 25.0% to about 35.0% alcohol solution by weight based on the hop tincture. Still other embodiments include from about 28.0% to about 33.0% alcohol solution by weight based on the hop tincture. In any of these embodiments, the alcohol solution may include depotabilizing agents and may therefore be a depotabilized alcohol solution. In various embodiments, the alcohol solution may help alter the ionic charge of the isohumulones, which may reduce foaming and render the tincture more suitable for use in a carbonated beverage as opposed to a brewed alcoholic beverage.

In various embodiments, the hop tincture further includes water. Water may be included, for example, to adjust the concentrations of the hop extract and/or alcohol solution. Accordingly, in various embodiments, the balance of the volume of the hop tincture is water. In some embodiments, the hop tincture includes up to about 70% water by weight based on the hop tincture. In some embodiments, the hop tincture includes from about 50.0% to about 70.0% water by weight based on the hop tincture. Some embodiments include from about 55.0% to about 65.0% water by weight based on the hop tincture. Still other embodiments include from about 57.0% to about 62.0% water by weight based on the hop tincture. It is further contemplated that the hop tincture may be concentrated and diluted with a suitable amount of water when it is mixed to form a carbonated beverage.

Various embodiments further include at least one hop extract solution. In various embodiments, the hop tincture includes from about 5.0% to about 50.0% hop extract solution by weight based on the hop tincture. In some embodiments, the hop tincture includes from about 5.0% to about 15.0% hop extract solution by weight based on the hop tincture. Still other embodiments include from about 8.0% to about 12.0% hop extract solution by weight based on the hop tincture. The hop extract solution includes one or more hop extracts in the form of iso-α-acids. In various embodiments, the hop extract solution includes tetrahydroiso-α-acid, rho-iso-α-acid, hexahydroiso-α-acid, salts thereof, or combinations thereof. In some embodiments, the iso-α-acid(s) are present in the form of potassium salts. In various embodiments, the hop extract solution includes from about 8.0% to about 40.0% hop extract by weight based on the hop extract solution. In some embodiments, the hop extract solution includes from about 8.0% to about 12.0% hop extract by weight based on the hop extract solution. In some embodiments, the hop extract solution includes from about 30.0% to about 40.0% hop extract by weight based on the hop extract solution.

In some embodiments, the hop extract solution includes from about 8.0% to about 12.0% by weight tetrahydroiso-α-acid based on the hop extract solution. The tetrahydroiso-α-acid may be in the form of a potassium salt. In other embodiments, the hop extract solution includes from about 8.0% to about 12.0% by weight hexahydroiso-α-acid. The hexahyrdoiso-α-acid may be in the form of a potassium salt. In some embodiments, the hexahyrdoiso-α-acid may be combined with from about 0.5% to about 2.0% by weight tetrahydroiso-α-acid in the hop extract solution. In still other embodiments, the hop extract solution includes from about 30.0% to about 40.0% rho-iso-α-acid. The rho-iso-α-acid may be in the form of a potassium salt.

In various embodiments, the hop extract solution may be purchased. Commercially available hop extract solutions include, by way of example and not limitation, Tetra Iso-Extract—10%, Hexa-Iso-Extract, and Rho-Iso-Extract—35%, each of which is commercially available from Hopsteiner (New York).

As an alternative to purchasing a commercially available hop extract solution, the hop extract solution may be manufactured by processing hops leaves. By way of example, and not limitation, the hop extract solution can be formed from pelletized hop leaves that are flushed with CO₂. In various embodiments, liquid CO₂ is removed from a working tank and compressed from about 60 bar up to about 280 bar using a high pressure pump. Next, a heat exchanger warms the CO₂ from about 22° C. to about 55° C. to form supercritical CO₂. The supercritical CO₂ is then fed into an extractor where it is flushed through the hop pellets. This can be, for example, from bottom to top of a closed extractor. The flushing of the hop pellets with the supercritical CO₂ extracts bitter aroma substances, or resins. The supercritical CO₂ along with the resins are then fed into a separator/evaporator where the pressure is reduced to convert the supercritical CO₂ into a gas. The conversion of the CO₂ into a gas yields the resin extract, which may be further processed. In various embodiments, the CO₂ gas is then condensed and transferred back to the working tank for reuse.

In various embodiments, the resin extract contains alpha-acids. The alpha-acids can include, by way of example and not limitation, humulone, cohumolone, adhumulone, prehumulone, and poshumolone. These alpha-acids may be converted into iso-α-acids by boiling the alpha-acids in alkaline water in the presence of a catalyst, such as MgSO₄. Tetrahydro-iso-α-acids may be obtained via hydrogenation of iso-α-acids in the presence of a Pd based catalyst. The reduction may be, in some embodiments, a solvent-free process. In various embodiments, tetrahydro-iso-α-acids may be further reduced using NaBH₄ in alkaline water to obtain hexahydro-iso-α-acids. Rho-iso-α-acids, also known as dihydro-iso-α-acids, may be obtained by a borohydride-based reduction of the carbonyl group in the iso-α-acids.

In some embodiments, the hop tincture also includes at least one hop essential oil. The hop essential oil produces a hop aroma that may be used to enhance the hop tincture. Some embodiments include from about 0.5% to about 1.5% hop essential oil by weight based on the hop tincture. The hop essential oil can include, by way of example and not limitation, myrcene, humulene, caryophyllene, or combinations thereof. In particular embodiments, the hop essential oil includes from about 55.0% to about 75.0% myrcene, from about 8.0% to about 15.0% humulene, and from about 5.0% to about 10.0% caryophyllene. In some embodiments, the hop essential oil may be diluted with ethanol, ethanol and water, or propylene glycol. In particular embodiments, the hop essential oil is diluted to 1.0%. The hop essential oil may be, for example, hop essential oil that is commercially available, such as Hop Oil from Hopsteiner (New York).

In various embodiments, the hop tincture is prepared by mixing the components of the hop tincture in a vessel. For example, hop extract solution, alcohol solution, and water are added to a vessel. The components are mixed to form a homogenous mixture and chilled to a temperature from about −5° C. to about 5° C. The mixture is held at this temperature for from about 6 to about 24 hours.

The mixture is then filtered to yield the hop tincture. The filtering removes insoluble materials and sediment and achieves a desired turbidity. For example, the alcohol solution may additionally or alternatively shock hop polyphenols present in the iso-α-acid mixtures and any terpene oxidative compounds and/or waxes in solution. Filtering removes these components from the hop tincture and reduces the clouding of the mixture. Additionally, the chilling of the mixture may shock remaining free alpha acids from the solution, which are removed by filtering. Turbidity may be measured using a nephelometer. In various embodiments, the turbidity is less than about 10 Nephelometric Turbidity Units (NTU). In some embodiments, the turbidity is less than about 5 NTU. Finally, the hop tincture is analyzed for the total alpha acid content using a spectrophotometer, HPLC, mass spectrometer, or via solvent extraction.

### EXAMPLES

It is believed that the various embodiments described hereinabove will be further clarified by the following examples.

### Examples 1-3

Three hop tinctures were made by combining water, depotabilized alcohol solution, and a hop extract solution. For each example, the depotabilized alcohol solution was 190 proof (95% alcohol by volume) ethyl alcohol derived from cane sugar. Hop extract solutions were purchased from Hopsteiner. The hop essential oils were also purchased from Hopsteiner. Table 1 provides the components in % by weight of the hop tincture and in ppm of iso-α-acids in each of the hop tinctures.

TABLE 1
Hop Tinctures

| | Example 1 | | Example 2 | | Example 3 | |
|---|---|---|---|---|---|---|
| | % of | ppm in | % of | ppm in | % of | ppm in |
| | hop | hop | hop | hop | hop | hop |
| | tincture | tincture | tincture | tincture | tincture | tincture |
| water | 60.0 | N/A | 60.0 | N/A | 60.0 | N/A |
| depotabilized | 30.0 | N/A | 30.0 | N/A | 30.0 | N/A |
| alcohol | | | | | | |
| Hex-Iso- | 10.0 | 1000 | 0.0 | 0.0 | 0.0 | 0.0 |
| Extract | | | | | | |
| Tetra-Iso | 0.0 | 0.0 | 10.0 | 1000 | 0.0 | 0.0 |
| Extract (10%) | | | | | | |
| Rho-Iso- | 0.0 | 0.0 | 0.0 | 0.0 | 10.0 | 3000 |
| Extract (35%) | | | | | | |
| Hop Oil (hop | ~1.0 | N/A | ~1.0 | N/A | ~1.0 | N/A |
| essential oils) | | | | | | |

The components for each hop tincture were combined in a vessel, mixed to form a homogenous mixture, and chilled to a temperature of about −1.11° C. Each mixture was held at this temperature for from about 6 to about 24 hours.

Each mixture was then filtered to yield the hop tincture. The turbidity for each hop tincture was less than about 5 NTU.

### Examples 4-7

Each of the three hop tinctures of Examples 1-3 were used to formulate a non-alcoholic carbonated beverage. Each non-alcoholic carbonated beverage was formed by mixing water, a hop tincture, one or more natural flavors, sweetener and citric acid. In particular, a “throw syrup batch” was formed by adding a hop tincture, a natural flavor, sweetener, and citric acid to a container a high concentration to form a syrup. Sweeteners added to each formula included sugar and stevia in the form of a 76.5° Bx aqueous solution. The syrup was then added to bottles at a predetermined “throw” of 5:1 (water-to-syrup ratio) and pre-carbonated water was then added to bottles before the contents were carbonated at 2.3V CO₂. Table 2 provides the components in % by weight of carbonated beverage of the carbonated beverages.

TABLE 2
Carbonated Beverages

| | Example 4 | Example 5 | Example 6 | Example 7 |
|---|---|---|---|---|
| | % of | % of | % of | % of |
| | carbonated | carbonated | carbonated | carbonated |
| | beverage | beverage | beverage | beverage |
| water | 94.84 | 94.69 | 94.64 | 92.06 |
| sweetener | 4.78 | 4.78 | 4.78 | 7.17 |
| citric acid | 0.10 | 0.20 | 0.20 | 0.45 |
| hop tincture | 0.0 | 0.0 | 0.0 | 0.08 |
| (Ex. 1) | | | | |
| hop tincture | 0.05 | 0.05 | 0.05 | 0.10 |
| (Ex. 2) | | | | |
| hop tincture | 0.05 | 0.05 | 0.05 | 0.12 |
| (Ex. 3) | | | | |
| natural flavor | 0.18 | 0.23 | 0.28 | 0.02 |

When the hop tinctures were included in non-alcoholic carbonated beverages, the resultant beverages had a detectable bitter flavor without the use of quinine. In particular, each of the carbonated beverages included 48 ppm of iso-α-acids, which corresponds to an IBU of 48. The bitterness of the beverages may appeal to consumers that traditionally consume tonic water or other quinine-containing beverages and/or to consumers that prefer beverages with a “hoppy” flavor, such as certain beers.

It should now be understood that embodiments of the present disclosure enable a non-alcoholic carbonated beverage to be flavored using hop extracts while retaining the bitter taste produced by quinine and desired by consumers. Moreover, various embodiments enable the hop tincture to be made by blending one or more iso-α-acids with alcohol and water. Other advantages will be appreciated by one skilled in the art.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A hop tincture comprising:
from about 20.0% to about 95.0% alcohol solution by weight based on the hop tincture; and
from about 5.0% to about 50.0% at least one hop extract solution by weight based on the hop tincture.

2. The hop tincture of claim 1, wherein the at least one hop extract solution comprises tetrahydroiso-α-acid, rho-iso-α-acid, hexahydroiso-α-acid, salts thereof, or combinations thereof.

3. The hop tincture of claim 2, wherein the at least one hop extract solution has a concentration of from about 8.0% to about 40.0% hop extract by weight based on the hop extract solution.

4. The hop tincture of claim 1, further comprising from about 0.5% to about 1.5% at least one hop essential oil by weight based on the hop tincture.

5. The hop tincture of claim 4, wherein the at least one hop essential oil comprises myrcene, humulene, caryophyllene, or combinations thereof.

6. The hop tincture of claim 1, wherein the hop tincture comprises:
from about 20.0% to about 40.0% alcohol solution by weight based on the hop tincture;
from about 5.0% to about 15.0% at least one hop extract solution by weight based on the hop tincture, the at least one hop extract solution comprising tetrahydroiso-α-acid or salts thereof; and
from about 50.0% to about 70.0% water by weight based on the hop tincture.

7. The hop tincture of claim 1, wherein the hop tincture comprises:
from about 20.0% to about 40.0% alcohol solution by weight based on the hop tincture;
from about 5.0% to about 15.0% at least one hop extract solution by weight based on the hop tincture, the at least one hop extract solution comprising rho-iso-α-acid or salts thereof; and
from about 50.0% to about 70.0% water by weight based on the hop tincture.

8. The hop tincture of claim 1, wherein the hop tincture comprises:
from about 20.0% to about 40.0% alcohol solution by weight based on the hop tincture;
from about 5.0% to about 15.0% at least one hop extract solution by weight based on the hop tincture, the at least one hop extract solution comprising hexahydroiso-α-acid or salts thereof; and
from about 50.0% to about 70.0% water by weight based on the hop tincture.

9. A carbonated beverage comprising:
water;
a sweetener;
an acidulant; and
a hop tincture comprising:
from about 20.0% to about 95.0% alcohol solution by weight based on the hop tincture;
from about 5.0% to about 50.0% at least one hop extract solution by weight based on the hop tincture.

10. The carbonated beverage of claim 9, wherein the carbonated beverage is non-alcoholic.

11. The carbonated beverage of claim 9, wherein the at least one hop extract solution comprises tetrahydroiso-α-acid, rho-iso-α-acid, hexahydroiso-α-acid, salts thereof, or combinations thereof.

12. The carbonated beverage of claim 9, wherein the hop tincture further comprises from about 0.5% to about 1.5% at least one hop essential oil by weight based on the hop tincture.

13. The carbonated beverage of claim 9, wherein the carbonated beverage comprises from about 1 to about 120 ppm of at least one iso-α-acid.

14. A method of making a hop tincture comprising:
mixing components of the hop tincture in a vessel, the components comprising:
from about 20.0% to about 95.0% alcohol solution by weight based on the hop tincture;
from about 5.0% to about 50.0% at least one hop extract solution by weight based on the hop tincture;
chilling the mixed components to a temperature from about −5° C. to about 5° C. for from about 6 to about 24 hours; and
filtering the mixed components to yield the hop tincture.

15. The method of claim 14, wherein the components further comprise from about 0.5% to about 1.5% at least one hop essential oil by weight based on the hop tincture.

16. The method of claim 15, wherein the at least one hop essential oil comprises myrcene, humulene, caryophyllene, or combinations thereof.

17. The method of claim 14, wherein the at least one hop extract solution comprises tetrahydroiso-α-acid, rho-iso-α-acid, hexahydroiso-α-acid, salts thereof, or combinations thereof.

18. The method of claim 14, wherein the at least one hop extract solution has a concentration of from about 8.0% to about 40.0% hop extract by weight based on the hop extract solution.

19. The method of claim 18, wherein the hop extract comprises tetrahydroiso-α-acid, rho-iso-α-acid, hexahydroiso-α-acid, salts thereof, or combinations thereof.

20. The method of claim 14, wherein the components comprise:
from about 20.0% to about 40.0% alcohol solution by weight based on the hop tincture;
from about 5.0% to about 15.0% at least one hop extract solution by weight based on the hop tincture, the at least one hop extract solution comprising hexahydroiso-α-acid or salts thereof; and
from about 50.0% to about 70.0% water by weight based on the hop tincture.
